(19) United States
(12) Patent Application Publication
(10) Pub. No.: US 2013/0010953 A1
(43) Pub. Date: Jan. 10, 2013

(54) ENCRYPTION AND DECRYPTION METHOD

(75) Inventors: Yannick Seurin, Saulx Les Chartreux (FR); Henri Gilbert, Bures Sur Yvette (FR)

(73) Assignee: FRANCE TELECOM, Paris (FR)

(21) Appl. No.: 13/517,905

(22) PCT Filed: Dec. 13, 2010
(86) PCT No.: PCT/FR10/52693

§ 371 Date: Sep. 7, 2012

(30) Foreign Application Priority Data
Dec. 22, 2009 (FR) 09 59425

(51) Int. Cl. H04L 9/28; H03M 13/05

(52) U.S. Cl. 380/255

(57) ABSTRACT

A method and apparatus are provided for encrypting a plaintext message element into a ciphertext message element associated with a random vector a first subset of encrypting users. The message element is encoded using an error correcting code and then encrypted by a secret matrix, parameterized by the random vector and with noise added by a noise vector. The method includes obtaining the secret matrix parameterized by the random vector and with noise by adding together user secret matrices specific to each of the encryption users. The user secret matrices are parameterized by the random vectors and having noise added by respective noise vectors specific to the encrypting users.

### CROSS-REFERENCE TO RELATED APPLICATIONS

This Application is a Section 371 National Stage Application of International Application No. PCT/FR2010/052693, filed Dec. 13, 2010, which is incorporated by reference in its entirety and published as WO 2011/083232 on Jul. 14, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to the field of secret key cryptography. It relates to an encryption and decryption method.

More precisely, the disclosure enables a set of users to share the ability to encrypt or decrypt a message with a secret key, without any of the users that have contributed to the encryption having knowledge of the key.

A particularly advantageous application of the present disclosure lies in activities that are critical and where, for security reasons, confidence is distributed between a predefined number of users. It is thus necessary for these users to collaborate with one another in order to encrypt a plaintext message, or to decrypt a ciphertext message. The ability to encrypt or decrypt a message is thus not held by any single person. For example, opening a bank safe, or signing on behalf of a business may advantageously make use of the methods of the disclosure. A particularly advantageous application of the disclosure lies in electronic voting systems.

### BACKGROUND OF THE DISCLOSURE

In symmetrical cryptography, the sender and the recipient of a message share knowledge of a common secret key K. This enables the sender to transform a plaintext message into a cryptogram or ciphertext message, and it enables the recipient to recover the plaintext message from the ciphertext message.

Circumstances exist in which it is desirable to share the ability to encrypt or decrypt a message between a plurality of users who must therefore necessarily collaborate in order to perform an operation. For example, such a function may be required in a business where it must not be possible to disclose information unless n officers are in agreement for decrypting it.

Sharing the decryption function has already been studied, and solutions exist in the context of asymmetrical encryption. With symmetrical encryption, one known technique consists in sharing a secret key K by means of a secret sharing scheme, e.g. the scheme presented by Shamir (A. Shamir, “How to share a secret”, in Communication of the ACM, Vol. 22, No. 11, pp. 612-613, 1979). In that scheme, a secret is shared between n users and it suffices for t of them to put their shares of the secret in common in order to reconstitute the secret. However, with that scheme, once the required number of users have collaborated on a first occasion and put their shares of the secret in common, the secret is reconstituted. Each of the users can then decrypt any ciphertext message and can encrypt any plaintext message. This guarantees a high level of security for the first encryption/decryption operation only. In order to maintain a high level of security for a subsequent operation of encrypting and decrypting a message, it is therefore necessary to distribute a new secret to the n users, in compliance with the secret sharing scheme that is in use. Furthermore, such a scheme is not reconfigurable in the sense that once a group of n users is established and once a secret has been shared between those n users, it is not possible for a subset of p out of those n users to encrypt a message, e.g. for the attention of the n−p other users, without redefining the sharing of a new secret adapted to that new configuration.

### SUMMARY

An exemplary embodiment of the present invention serves to improve the situation by proposing a method of encrypting a plaintext message element x into a ciphertext message element associated with a random vector (a,y) by means of a first subset of p encrypting users, wherein the message element is encoded using an error correcting code C and then encrypted by means of a secret matrix M parameterized by the random vector a and with noise added by means of a noise vector ε, the method being characterized in that it comprises a step of obtaining said secret matrix parameterized by the random vector and with noise by adding together user secret matrices specific to each of the p encryption users, said user secret matrices being parameterized by the random vector and having noise added by respective noise vectors specific to the p encrypting users.

It can immediately be seen that by definition the term “message element” comprises all or part of a message.

With the method of an embodiment of the invention, the encryption function is shared between p encrypting users who must collaborate in order to encrypt the plaintext message element. None of the p encrypting users has knowledge at any time of the secret matrix used during the encryption operation. It is necessary for the p users to collaborate to perform the encryption operation, otherwise nobody is in a position to perform the operation. Furthermore, any new encryption operation requires the users to collaborate once more, even if the same secret matrix is involved, or in other words even if the same p encrypting users are involved.

Furthermore, the encryption function of an embodiment of the invention can be reconfigured in the sense that a new group of q encrypting users, different from the group of p encrypting users, can be defined in order to share the encrypting function between those q users without it being necessary for any specific preliminary configuration such as distributing new specific secret matrices to each of the q users of the new group.

The method of an embodiment of the invention also possesses security that has been proved, which is rare with symmetrical cryptography. The encryption of an embodiment of the invention relies on symmetrical probabilistic encryption for which it is possible to prove security by a reductionist approach consisting in converting the security into an assumption about the difficulty of solving a known problem. In other words, it is possible to prove that in order to break the security of the encryption method, an attacker must be capable of solving a known problem, which problem is assumed to be difficult. In the context of the present encryption, the well-defined and well-known problem is the learning parity with noise (LPN) problem.

Furthermore, the method of an embodiment of the invention requires only limited calculation capacity. Thus, the method finds an advantageous application in environments where calculation capacity is limited, even though the required level of security is high. For example, the method may be implemented in user terminals of the mobile terminal type.

Advantageously, the first subset of p encrypting users and a second subset of q decrypting users together form a set of p+q users, and there is provided a step of each user of said set receiving a specific user secret matrix, the sum of the p+q specific user matrices being equal to a null matrix.

In a preliminary configuration stage, specific secret matrices are distributed to a set of n users made up of p encrypting users and q decrypting users (n=p+q). The sum of the n specific matrices of the n users is equal to the null matrix. This preliminary stage is performed only once. By using the encryption or decryption method of an embodiment of the invention, none of the users, at any time, has knowledge of the secret matrix used for encrypting the plaintext message element. The secret matrix is never calculated as such, but rather collaboration between all of the encrypting users makes it possible to obtain the secret matrix that has been parameterized by a random quantity and that has added noise. Thus, the specific secret matrices distributed during the preliminary stage can be used for successive encryption and decryption operations without the level of security of those operations being harmed.

Advantageously, the method of an embodiment of the invention includes a step of:

for each of p+q−1 users of said set, generating a random specific user secret matrix; and

for the p+q^{th} user, generating a specific user secret matrix adapted so that the sum of the secret matrices of the p+q^{th} user plus the p+q−1 random secret matrices is equal to the null matrix.

This implementation provides simple means for generating the secret matrices specific to the n users, with the sum of these n specific matrices being equal to the null matrix. Thus, for nusers, n−1 matrices are generated randomly. The n^{th} and last matrix is then obtained by solving a simple equation such that the sum of this n^{th} matrix with the n−1 randomly generated matrices is equal to the null matrix. Thus, the preliminary stage of generating and distributing specific matrices is fast and requires few calculation resources.

An embodiment of the invention also provides a decryption method performed by a second subset of q decrypting users on the ciphertext message element associated with the random vector (a,y) and obtained by the encryption method of an embodiment of the invention, the decryption method comprising the steps of:

the q decrypting users calculating q respective vectors, each decrypting user vector comprising a matrix specific to said user parameterized by the random vector;

for at least q−1 decrypting users, generating a noise vector specific to that user;

calculating the sum of the ciphertext message element, plus the q calculated respective vectors, plus the at least q−1 generated noise vectors; and

decoding the calculated sum using the error correcting code used during encryption so as to obtain the plaintext message element.

With the decryption method, none of the decrypting users has knowledge, at any time, of the secret matrix used during the decryption operation. The secret matrix used during this operation is never calculated as such. The ciphertext is decrypted as a result of collaboration between all of the decrypting users.

In an implementation of the decryption method, the sum is calculated and the decoding is performed by one of the q decrypting users, referred to as the master decrypting user, and the sum contains the noise vectors generated for the q−1 other users, excluding the noise vector of the master decrypting user.

In this implementation, a decrypting user acts as the decryption entity. Thus, that user receives from all of the other decrypting users a contribution to the decryption, which contribution comprises a respective vector and a noise vector generated by the noise source specific to each of the users. In order to decrypt the ciphertext, the decrypting user must then calculate the sum of the ciphertext, plus the contributions received from the other users, plus his or her own contribution. As a general rule his or her own contribution comprises a respective vector and a noise vector generated by that user's own noise source. Nevertheless, since that user knows the value of his or her own noise vector, it can be eliminated from the contribution. Thus, in order to decrypt the ciphertext, the decrypting user calculates the sum of the ciphertext plus the contributions from the other users, plus that user's respective vector. The total noise obtained by summing the noise from the users is therefore smaller, in comparison with the implementation in which the decryption entity calculates a total noise equal to the sum of the noise vectors from all of the decrypting users. The decoding procedure is thus made easier.

An embodiment of the invention also provides an encryption entity suitable for encrypting a plaintext message element into a ciphertext message element associated with a random vector (a,y) for a subset of p encrypting users, the entity comprising:

means for obtaining a random vector;

encoding means adapted to encode the message element by means of an error correcting code; and

encryption means adapted to encrypt said encoded element by means of a secret matrix parameterized by the random vector and including noise, the parameterized and noisy matrix being obtained by adding secret user matrices specific to the p encrypting users, said secret user matrices being parameterized with the random vector and having noise added by the noise vectors specific to the p encrypting users.

An embodiment of the invention also provides an encryption and decryption system comprising an encryption entity of an embodiment of the invention, and a decryption entity comprising:

reception means adapted to receive a ciphertext message element associated with a random vector (a,y), and to receive at least q−1 noise vectors generated by q−1 decrypting users;

calculation means adapted to calculate the sum of the ciphertext message element plus the at least q−1 noise vectors; and

decoder means for decoding the calculated sum using the error correcting code used during encryption, in order to obtain the plaintext message element.

In an embodiment of the system of the invention, the decryption entity is a device of a decrypting user and further comprises: means for calculating a respective vector comprising a matrix specific to said user parameterized by the random vector.

An embodiment of the invention also provides a computer program for installing in a memory of an encryption entity and comprising instructions for implementing the steps of the encryption method of an embodiment of the invention when the program is executed by a processor.

An embodiment of the invention also provides a data medium having recorded thereon the above computer program.

An embodiment of the invention also provides a computer program for installing in a memory of a decryption entity and including instructions for implementing the steps of the decryption method of an embodiment of the invention when the program is executed by a processor.

An embodiment of the invention also provides a data medium having recorded thereon the above computer program.

### BRIEF DESCRIPTION OF THE DRAWINGS

Other characteristics and advantages can be better understood on reading the following description with reference to the accompanying drawings given by way of non-limiting example, and in which:

FIG. 1 is a flow chart of the steps of an encryption method in a particular implementation;

FIG. 2 is a flow chart of the steps of a method of decrypting a method encrypted using the encryption method of an embodiment of the invention, in a particular implementation;

FIG. 3 is a block diagram of a particular embodiment of an encryption entity adapted to implement the encryption method of an embodiment of the invention; and

FIG. 4 is a block diagram of a particular embodiment of a decryption entity adapted to implement the decryption method of an embodiment of the invention.

### DETAILED DESCRIPTION OF ILLUSTRATIVE EMBODIMENTS

The encryption/decryption method of an embodiment of the invention enables the encryption and decryption function to be shared between a plurality of users. This relies on symmetrical probabilistic encryption/decryption as described in the international patent application published under the No. WO 2009/095574. That application describes probabilistic encryption that, by definition, involves a random in the encryption and that also relies on the combination of encoding by an error correcting code and adding noise. The effects of that combination is to make it more difficult for an adversary to decrypt the ciphertext, while also being adapted to being eliminated naturally by the decoding of the error correcting code. With such encryption, it is possible to prove security by a reductionist approach consisting in converting security into an assumption about the difficulty of solving a known problem. In other words, it can be shown that in order to break the security of this encryption method, an attacker must be capable of solving a known problem that is assumed to be difficult. In the context of the present encryption, the well-defined and well-known problem is the learning parity with noise (LPN) problem.

More precisely, probabilistic symmetrical encryption between a sender and a receiver as described in the international application makes use of:

a binary error correcting code, written C, of length m, of dimension r, and of correction capacity t. The correcting code C is a function of a binary space of dimension r {0, 1}^{r} in a binary space of dimension m {0,1}^{m}. This function is adapted to transfer an r-bit message as an m-bit code word, where m>r, by adding redundancy bits. In addition, the correcting code C is adapted to guarantee that decoding enables the original message to be restored, even if some number of errors less than the correction capacity t have been added to the code word. The correcting code may be a block code, or a convolutional code;

a source of random bits or pseudo-random bits, written S that is accessible to the sender;

a source of Bernoulli noise B accessible to the sender and adapted to generate an m-bit binary noise vector ε. This source produces independent bits of value 1 with a probability η, and independent bits of value 0 with a probability 1−η, where η ∈ ]0,½[. In addition, the Bernoulli noise source B is adapted so that there is a very small probability that the Hamming weight associated with the noise vector ε is greater than the correction capacity t of the correcting code. By way of example, this threshold may be equal to 10⁻³. By definition, the Hamming weight of a binary vector is the number of bits in the vector that are not equal to 0, in other words the number of bits that are equal to 1. Thus, for most noise vectors ε generated by the source B, the Hamming weight of the vector ε, written Hwt(ε), is less than or equal to the correction capacity t of the correcting code C. In a variant, the sender tests the noise vector ε before adding it, in order to verify whether the condition Hwt(ε)≦t is indeed satisfied. If it is not satisfied, the sender regenerates the vector;

a matrix M of size k*m constituting the secret key shared between the sender and the receiver.

In order to encrypt a plaintext message element x having r bits, the sender performs the following operations:

obtaining a k-bit random vector a from the source S; and

then calculating a noisy vector:

y=C(x)⊕a·M⊕ε

where ε is an m-bit noise vector produced by the Bernoulli noise source B. The ciphertext sent to the receiver is then defined in a pair (a,y) made up of the ciphertext message element y and the random vector a used for encrypting said message element. In order to encrypt a message having R>r bits, the message is subdivided into r-bit message elements, possibly with predetermined values being added in order to make up a block to r bits, if the value R is not a multiple of r (this is commonly referred to as “padding”). The encryption procedure is then applied to each r-bit block.

When a receiver receives the pair (a,y), it adds to the ciphertext y its secret matrix parameterized by the random vector a, in other words it calculates y⊕a·M. Thereafter it decodes the result. If the Hamming weight of the noise vector ε that was added is less than the correction capacity t of the code, then the plaintext message is found.

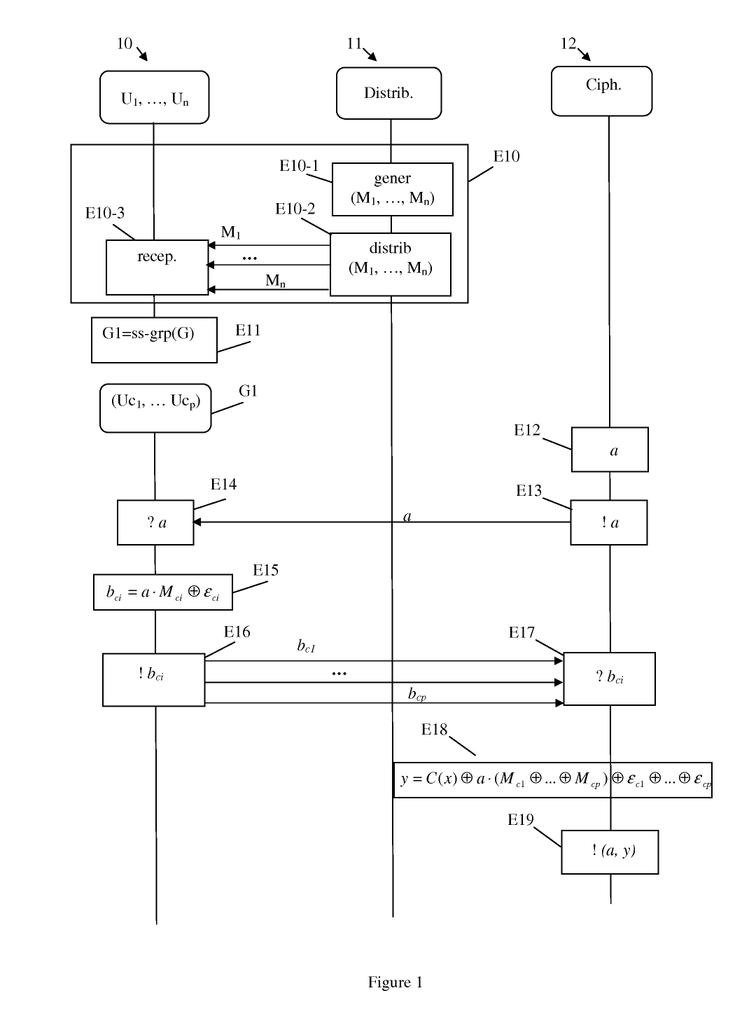

The steps of an encryption method in a particular implementation are described below with reference to FIG. 1.

Let there be a set 10 made up of n users U₁, . . . , Uₙ. In this set, it is considered that a plurality of users seek to collaborate in order to encrypt a plaintext message X having a size of R bits. It can immediately be observed that the message X is subdivided into a plurality of message elements x each having r bits, where r<R, possibly with added predetermined values in order to pad a block out to r bits, if the value R is not a multiple of r. Below, reference is made to encrypting a plaintext message element x. It should be understood that in order to encrypt the plaintext message X, the encryption method of an embodiment of the invention is applied to each of the plaintext message elements x that make up the plaintext message X.

A key-distribution entity 11 in which the users have confidence is adapted to distribute a secret key to each of the n users of the set 10, the key being in the form of a specific secret matrix of size k*m.

In the implementation described herein, an encryption entity 12 is adapted to calculate an encrypted version of the plaintext message element x from information received from the users collaborating in the encryption. In another implementation, it is one of the users (or several of them) amongst the set of users collaborating in the encryption who performs the calculation and acts as the encryption entity 12.

In a preliminary configuration stage E10, the key-distribution entity 11 generates and distributes n secret keys specific to the n users. The preliminary configuration stage E10 has a first step E10-1 of generating specific secret matrices. In this generation step E10-1, the key-distribution entity 11 generates n specific secret matrices in such a manner that the sum of the n generated matrices is equal to the null matrix. In other words, M₁ ⊕ . . . ⊕ Mₙ=0. In a second step E10-2 of transmission, the key-distribution entity 11 transmits to each of the n users U₁, . . . , Uₙ of the group 10 in secure manner that user's own secret matrix M₁, . . . , Mₙ. The specific secret matrices are received by each of the n users during a reception step E10-3.

The preliminary configuration stage E10 is performed once only.

In a following step E11 of setting up a group of encrypting users, a group G1 of p users U_{c1}, U_{c2}, . . . , U_{cp} of said encrypting users is set up, which users are to collaborate to encrypt the plaintext message element x. The group G1 constitutes a subset of the set of users 10.

The following steps relate to the group G1 of encrypting users.

In a step E12 of drawing a random vector, the encryption entity 12 generates in random manner a random vector a of k bits, and it distributes this vector a to the set of p encrypting users during a step E13 of sending the random vector.

The random vector a is received by each of the p encrypting users during a reception step E14.

In a step E15 of calculating specific vectors, each of the p encrypting users U_{ci}, where 1≦i≦p, calculates a vector b_{ci} equal to the secret matrix of said user, parameterized by the random vector a and adding thereto a noise vector ε_{ci} specific to the user. In other words, each encrypting user U_{ci} calculates b_{ci}=a·M_{ci}⊕ε_{ci}, where ε_{ci} is a noise vector of m produced by a Bernoulli noise source having a noise parameter η, the noise source being independent for each user. The encrypting users U_{ci} transmit their respective vectors b_{ci} to the encryption entity 12 in a step E16 of receiving the vectors.

The vectors b_{ci} from the p encrypting users are received by the encryption entity 12 during a step E17 of receiving the specific vectors.

In a step E18 of calculating the ciphertext, the encryption entity 12 calculates the encrypted version of the plaintext message element. For this purpose, the encryption entity 12 encodes the plaintext message x using the error correcting code C and adds to said encoded value the sum of the respective vectors b_{ci} received from the p encrypting users. In other words, the encryption entity 12 calculates:

y=C(x)⊕a·(M_{c1} ⊕ . . . ⊕M_{cp})⊕ ε_{c1} ⊕ . . . ⊕ ε_{cp}

This calculation is in conformity with a symmetrical probabilistic encryption in which the secret matrix is the sum of the respective secret matrices of the encrypting users, and the noise vector is equal to the sum of the respective noises produced by the p encrypting users. It should be observed that the ciphertext y is calculated by the encryption entity 12 without it having available at any time the secrete encryption matrix that is used, and specifically the sum of the specific matrices of the p encrypting users. The entity has received the specific vectors as calculated independently by each of the p encrypting users for the plaintext message x. At no time is the secret encryption matrix manipulated as such.

In a step E19 of sending ciphertext, the encryption entity 12 sends a pair (a,y) comprising the random vector a and the ciphertext y as calculated during the step E18 to a recipient entity (not shown in FIG. 1) suitable for decrypting the received ciphertext.

In a particular implementation of an embodiment of the invention, the secret matrices specific to each of the n users are Toeplitz matrices. It is known that in a Toeplitz matrix, the coefficients on a diagonal sloping down from left to right are the same. Thus, the set of coefficients of a specific secret matrix can be deduced from no more than the coefficients of the first row and of the first column of the matrix. Thus, it thus suffices for the users to store only the coefficients of the first row and of the first column of the conversion matrix in order to have all of the coefficients of their own respective secret matrices. It should be observed that if the sum of the coefficients of the first rows of the respective specific matrices of the n users is equal to 0, and if the sum of the coefficients of the first columns of the respective specific matrices of the n users is equal to 0, then the sum of the respective specific matrices of the n users is equal to the null matrix. Using Toeplitz matrices in the method of an embodiment of the invention is advantageous when the user equipments implementing the method possess little storage memory. This may apply when an embodiment of the invention is implemented in user mobile terminals.

The distribution of the secret matrices of the users performed in the step E10-2 of the preliminary configuration stage E10 may be implemented in compliance with various known existing procedures. For example, each user Uᵢ may travel in person to obtain the matrix from the key-distribution entity 11. In another implementation, the distribution is performed over a distribution channel that is made secure by cryptographic means that are well known to the person skilled in the art and based on public key cryptography, for example. In another implementation, a matrix is distributed to each user by telephone.

In an implementation, the step E10-1 of generating the specific secret matrices of the preliminary stage consists in the key-distribution entity 11 generating n−1 specific matrices for n−1 users in random manner. Thereafter, the key-distribution entity 11 calculates the n^{th} matrix specific to the n^{th} user, in such a manner that the sum of the n specific secret matrices is equal to the null matrix.

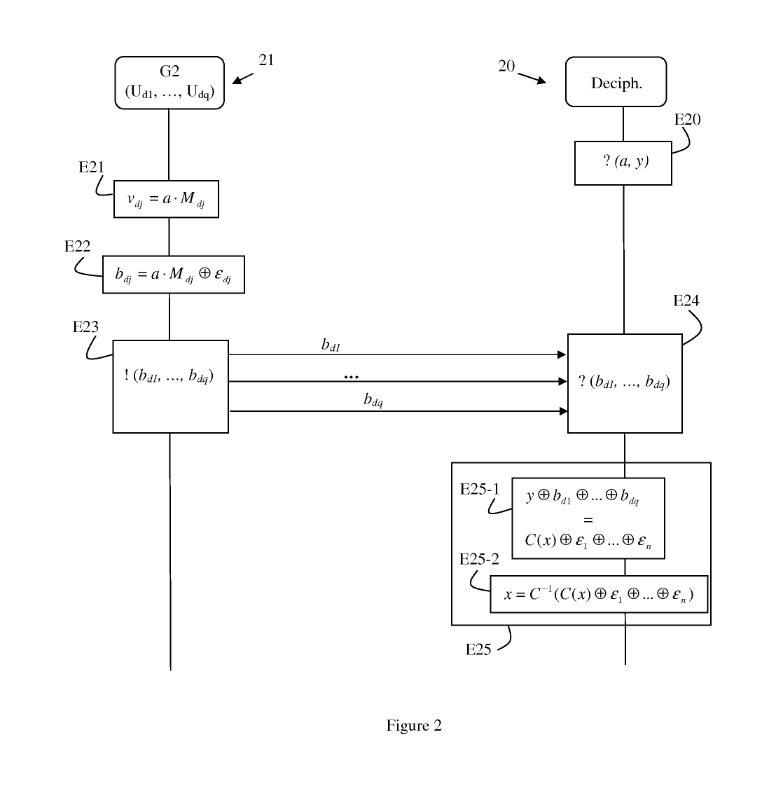

The steps of the decryption method in a particular implementation are described below with reference to FIG. 2.

In this implementation, a decryption entity 20 is in charge of decrypting a ciphertext y of a plaintext message x obtained by collaboration of a group G1 of p decrypting users U_{c1}, . . . , U_{cp} (not shown in FIG. 2), in application of the encryption method described with reference to FIG. 1.

In a step E20 of receiving a ciphertext, the decryption entity 20 receives, e.g. from an encryption entity 12 of FIG. 1 (not shown in FIG. 2), a pair (a,y) comprising the random vector a and the ciphertext y calculated in application of the encryption method described with reference to FIG. 1. The ciphertext has been obtained by collaboration between p encrypting users. It is destined for a group G2 of q so-called “decrypting” users U_{d1}, . . . , U_{dq} suitable for decrypting it by collaborating with one another. The set of p encrypting users and the set of q decrypting users make up the group 10 of n users in FIG. 1, so n is equal to the sum of p plus q.

In a step E21 of calculating respective vectors, the decrypting users U_{dj} calculate respective vectors v_{dj} comprising their own matrices M_{dj} parameterized by the random vector a. In a following step E22, the decrypting users add respective m-bit noise vectors ε_{dj} generated by respective Bernoulli noise sources B of parameter η to their respective vectors, the noise sources being independent from one user to another. In other words, each decrypting user U_{dj} calculates a noisy vector b_{dj}=a·M_{dj}⊕ε_{dj}. In a step E23 of transmitting the noisy vector, the decrypting users U_{dj} transmit their respective noisy vectors b_{dj} to the decryption entity 20.

In a reception step E24, the decryption entity 20 receives all of the respective noisy vectors b_{dj} from the decrypting users U_{dj}.

In a decrypting step E25, the decryption entity 20 decrypts the ciphertext message element y. For this purpose, the decryption entity 20 calculates, in a calculation substep E25-1, the sum of the ciphertext message element y plus the q respective noisy vectors b_{dj} from the decrypting users. In other words, the entity 20 calculates

y⊕b_{d1}⊕b_{d2}⊕ . . . ⊕b_{dq} (1)

Since:

y=C(x)⊕a·(M_{c1} ⊕ . . . ⊕ M_{cp})⊕ ε_{c1} α . . . ⊕ ε_{cp}

the sum (1) calculated by the decryption entity 20 is equal to:

C(x)⊕ a·(M₁ ⊕ . . . ⊕ Mₙ)⊕ ε′

where:

ε′−ε_{c1} ⊕ . . . ⊕ ε_{cp} ⊕ ε_{d1} ⊕ . . . ⊕ ε_{dq}=ε₁ ⊕ . . . ⊕ εₙ

is the total noise vector corresponding to the sum of the noise vectors of the encrypting users and of the decrypting users. The sum of the specific matrices for the p encrypting users U_{ci} plus the specific matrices of the q decrypting users U_{dj} is equal to the sum of the specific matrices of the n users. Since the sum of the secret matrices specific to the n users is equal to the null matrix, the sum (1) as calculated by the entity is equal to:

C(x)⊕ε′

In a decoding substep E25-2, the decryption entity 20 proceeds with decoding the calculated sum (1) using the error correcting code C. Providing the Hamming weight of the total error ε′ is less than the correction capacity t of the correcting code, then the decoding operation produces the plaintext message x.

In another implementation of an embodiment of the invention, there is no decryption entity 20 dedicated to the decryption operation. In this implementation, it is the decrypting users that perform the decryption. In this implementation, at the end of step E22, the decrypting users all send their respective noisy vectors to each of the other decrypting users, e.g. by a broadcast mechanism.

In another implementation, it is one particular decrypting user U_{dk} who performs the decryption operation. Under such circumstances, the user U_{dk} does not need to transmit his or her noisy vector to the other decrypting users. Thus, in this implementation, in the calculation substep E25-1, the decrypting user U_{dk} calculates the sum of his or her own respective vector, of the ciphertext message element y, and also of the respective noisy vectors that have been received from the other decrypting users. It should be observed that in this sum the user U_{dj} needs only to add his or her own noisy vector of value that is already known. Thus, the decrypting user U_{dk} calculates:

C(x)⊕a·(M₁ ⊕ . . . ⊕ Mₙ)⊕ ε_{c1} ⊕ . . . ⊕ ε_{cq} ⊕ ε_{d1} ⊕ . . . ⊕ ε_{d(k-1)} ⊕ ε_{d(K+1)} ⊕ . . . ⊕ ε_{dq}

Thus, the total noise is reduced, thereby facilitating the decoding operation performed during the substep E25-2. Naturally, in this implementation, the decoding operation is performed by the decoding user U_{dk}.

There follow a few examples of implementations of the encryption method using concrete parameters. It is recalled that the security of the encryption system depends on the difficulty of solving the LPN problem. This difficulty relies on the parameters k and η, corresponding to the number of bits in the random vector a and on the probability of any one bit of the noise vector ε having the respective value 1. It is therefore appropriate to select suitable values for these parameters that make it possible to guarantee good security for the system. Two examples of suitable values for the parameters k and η are as follows:

k=768, η=0.1

It should be observed that the error correcting code C that is used has an impact on the efficiency of the system but not on its security. If the code C is of dimension r, then the total size of the ciphertext element y for a plaintext message element x of r bits is (m+k) bits. The ciphertext is thus expanded to some extent, thereby encouraging the use of a value for r that is as great as possible and a value for m that is as small as possible, for constant k. The expansion factor is written as follows:

$$σ = \frac{( m + k )}{r}$$

Thereafter, in order to make it possible for the entity in charge of decryption, specifically the decryption entity 20 or, in another implementation, a decrypting user, to perform decryption, the correction capacity t and the length m of the code C must satisfy t>μ*m, where μ is the total noise that results from adding all of the user noise vectors. It is easily shown that when adding n independent noise vectors having a noise parameter η, the resulting noise parameter is given by:

$$μ = \frac{1}{2} - \frac{1}{2} {( 1 - 2 η )}^{n}$$

Thus, for a noise parameter η=0.1, when three independent noise vectors are added together, the resulting noise has μ=0.244. This situation corresponds by way of example to a situation in which the function is shared between four users and the decryption is performed by a decrypting user. Under such circumstances, the decrypting user can subtract the noise he or she has generated. The parameters of the code C are written [m,r,d], where m is the length of the code, r is its dimension, and d is its minimum dimension, the correction capacity t being associated with the minimum distance by the following relationship:

$$t = [ \frac{d - 1}{2} ]$$

It is possible to use a linear code having the parameters [64,4,33] that is capable of correcting 16 errors, so the expansion parameter is then σ=16.

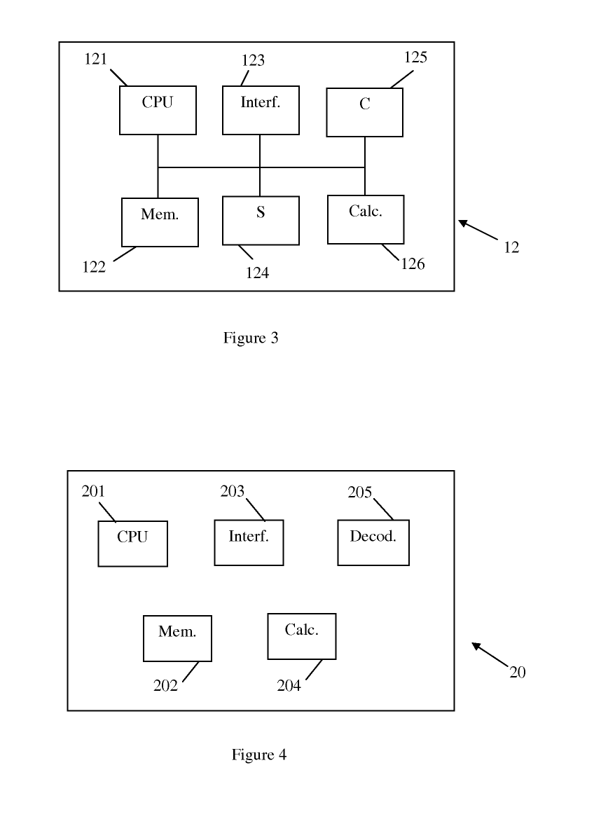

An encryption entity 12 suitable for implementing the encryption method is described below with reference to FIG. 3. By way of example, such an entity is a computer of the server type suitable for communicating with a plurality of encrypting users. The encryption entity 12 has a plurality of modules:

a central processor unit (CPU) or processor 121;

a memory 122 enabling calculations to be performed, serving to store software instructions corresponding to the steps of the above-described encryption method, and enabling them to be executed by the microprocessor 121; and

communications interfaces 123 suitable for sending a random vector a to the encrypting users, for receiving respective vectors from the encrypting users, and for transmitting to a second entity, e.g. a decryption entity, a pair (a,y) where a is the random vector and y is the encrypted version of a plaintext message x. The interfaces 123 serve to perform the steps E13 of sending the random vector, E16 of receiving the respective vectors, and E19 of sending the ciphertext. These steps are described above with reference to FIG. 1.

The encryption entity 12 also hosts an application in the form of a program, suitable for implementing the steps of the above-described encryption method. For this purpose, the entity 12 also comprises:

a pseudo-random generator 124 adapted to generate a random vector a. The generator 124 implements the above-described step E12 of drawing a random vector;

an encoding module 125 adapted to encode the plaintext message x by means of an error correcting code C; and

a calculation module 126 adapted to calculate the encrypted version of the plaintext message x from the encoded plaintext message and the respective vectors received from the encrypting users. The calculation performed by the module 126 complies with symmetrical probabilistic encryption in which the secret matrix is the sum of the respective secret matrices of the encrypting users, and the noise vector is equal to the sum of the respective noises produced by the p encrypting users. The calculation module 126 co-operates with the encoding module in order to obtain the encoded plaintext message. The encoding module 125 and the calculation module 126 implement the step E18 of calculating the ciphertext.

The modules 123, 124, 125, and 126 that implement the above-described encryption method are preferably software modules comprising software instructions for causing the steps of the encryption method to be executed.

An embodiment of the invention thus also provides:

a computer program including instructions for implementing the encryption method as described above when the program is executed by a processor; and

a computer-readable recording medium having the above-described program recorded thereon.

The software modules may be stored in or transmitted by a data medium. These may comprise a hardware storage medium, e.g. a compact disk read only memory (CD-ROM), a magnetic floppy disk, or a magnetic hard disk, or indeed a transmission medium such as a signal, or a telecommunications network.

A decryption entity 20 suitable for implementing the decryption of ciphertext obtained in accordance with the above-described encryption method is described below with reference to FIG. 4. By way of example, such an entity is a computer of the server type suitable for communicating with a plurality of decrypting users. The decryption entity 20 comprises a plurality of modules:

a processor or CPU 201;

a memory 202 enabling calculations to be performed, enabling software instructions corresponding to the steps of the above-described decryption method to be stored, and enabling them to be executed by the processor 201; and

communications interfaces 203 adapted to receive a pair (a,y) from the encryption entity 12, where a is the random vector and y is an encrypted version of a plaintext message x, and to receive respective noisy vectors from at least (q−1) decrypting users. In the implementation where the decryption entity is an entity that is independent of the users, the interfaces 203 receive q noisy vectors from q decrypting users. In the implementation where the decryption is performed by a particular decrypting user device, its interfaces receive only (q−1) respective noisy vectors from the (q−1) other users. The interfaces 203 enable the step E20 of receiving ciphertext and the step E24 of receiving respective noisy vectors from the decrypting users to be performed. These steps are described above with reference to FIG. 2.

The decryption entity 20 also houses an application in the form of a program suitable for implementing the steps of the above-described decryption method. For this purpose, the entity 20 also comprises:

a calculation module 204 adapted to calculate the sum of the ciphertext message element y plus at least (q−1) noisy vectors received from the decrypting users. In the implementation where decryption is performed by a particular decrypting user device, and where the interfaces 203 receive only (q−1) respective noisy vectors, the calculation module 204 calculates the sum of the ciphertext, plus the (q−1) noisy vectors plus the non-noisy vector specific to the decrypting user device. It should be recalled that the non-noisy vector is equal to the matrix specific to this decrypting user using the random vector as the parameter. In this implementation, there is no need for the user device that performs decryption to add in its own noise vector, which it already knows. The module 204 performs the above-described calculation substeps E25-1; and

a decoding module 205 adapted to decode the code word C(x) obtained by the calculation module 204 by means of the error correcting code C. The module 205 implements the above-described decoding substep E25-2. The calculation module 204 and the decoding module 205 perform the above-described decrypting step E25.

The modules 203, 204, and 205 that implement the above-described decryption method are preferably software modules comprising software instructions for causing the steps of the decryption method to be performed.

An embodiment of the invention thus also provides:

a computer program including instructions for implementing the encryption method as described above when the program is executed by a processor; and

a computer-readable recording medium having the above-described program recorded thereon.

The software modules may be stored in or transmitted by a data medium. These may comprise a hardware storage medium, e.g. a CD-ROM, a magnetic floppy disk, or a magnetic hard disk, or indeed a transmission medium such as a signal, or a telecommunications network.

The invention is not limited to an encryption or decryption entity of the server type. In an embodiment, the encryption or decryption entity is a user mobile terminal. In addition, since the encryption is symmetrical, it can be understood that an entity suitable for performing encryption is also suitable for performing decryption. Such an entity is therefore suitable for implementing the encryption method and the decryption method.

1. A method of encrypting a plaintext message element (x) into a ciphertext message element associated with a random vector (a,y) by a first subset of p encrypting users, wherein the message element (x) is encoded (C(x)) using an error correcting code (C) and then encrypted by a secret matrix (M) parameterized by the random vector (a) and with noise added by a noise vector (ε), wherein the method comprises:
obtaining said secret matrix (M) parameterized by the random vector and with noise by adding together, with a processing device, user secret matrices specific to each of the p encryption users, said user secret matrices being parameterized by the random vector and having noise added by respective noise vectors specific to the p encrypting users.

2. A method according to claim 1, wherein the first subset of p encrypting users and a second subset of q decrypting users together form a set of p+q users, and the method comprises a step of each user of said set receiving a specific user secret matrix, the sum of the p+q specific user matrices being equal to a null matrix.

3. A method according to claim 2, including:
for each of p+q−1 users of said set, generating a random specific user secret matrix; and
for the p+q^{th} user, generating a specific user secret matrix adapted so that the sum of the secret matrices of the p+q^{th} user plus the p+q−1 random secret matrices is equal to the null matrix.

4. A decryption method performed by a second subset of q decrypting users on a ciphertext message element associated with a random vector by a first subset of p encrypting users, wherein the message element is encoded using an error correcting code and then encrypted by a secret matrix parameterized by the random vector and with noise added by a noise vector, the decryption method comprising:
the q decrypting users calculating q respective vectors (v_{dj}), each decrypting user vector comprising a matrix specific to said user parameterized with the random vector;
for at least q−1 decrypting users, generating a noise vector specific to that user;
calculating with a processing device the sum of the ciphertext message element, plus the q calculated respective vectors, plus the at least q−1 generated noise vectors; and
decoding the calculated sum using the error correcting code used during encryption so as to obtain the plaintext message element.

5. The decryption method according to claim 4, wherein the sum is calculated and the decoding is performed by one of the q decrypting users, referred to as the master decrypting user, and the sum contains the noise vectors generated for the q−1 other users, excluding the noise vector of the master decrypting user.

6. An encryption entity suitable for encrypting a plaintext message element (x) into a ciphertext message element associated with a random vector (a,y) for a subset of pencrypting users, the entity comprising:
means for obtaining a random vector (a);
encoding means for encoding the message element by an error correcting code (C); and
encryption means for encrypting said encoded element of a secret matrix (M) parameterized with the random vector and including noise, the parameterized and noisy matrix being obtained by adding secret user matrices specific to the p encrypting users, said secret user matrices being parameterized with the random vector (a) and having noise added by the noise vectors specific to the p encrypting users.

7. An encryption and decryption system comprising:
an encryption entity claim 6, suitable for encrypting a plaintext message element (x) into a ciphertext message element associated with a random vector (a,y) for a subset of p encrypting users, the encryption entity comprising:
means for obtaining a random vector (a);
encoding means for encoding the message element by an error correcting code (C); and
encryption means for encrypting said encoded element of a secret matrix (M) parameterized with the random vector and including noise, the parameterized and noisy matrix being obtained by adding secret user matrices specific to the p encrypting users, said secret user matrices being parameterized with the random vector (a) and having noise added by the noise vectors specific to the p encrypting users; and
a decryption entity comprising:
reception means receiving a ciphertext message element associated with the random vector (a,y), and for receiving at least q−1 noise vectors generated by q−1 decrypting users;
calculation means for calculating the sum of the ciphertext message element (y) plus the at least q−1 noise vectors; and
decoder means for decoding the calculated sum using the error correcting code used during encryption, in order to obtain the plaintext message element.

8. The system according to claim 7, wherein the decryption entity is a device of a decrypting user and further comprises:
means for calculating a respective vector (v_{dj}) comprising a matrix specific to said user parameterized with the random vector (a).

9. (canceled)

10. A non-transitory data medium having recorded thereon a computer program comprising instructions which, when executed by a processor perform steps of:
encrypting a plaintext message element into a ciphertext message element associated with a random vector by a first subset of p encrypting users, wherein the message element is encoded using an error correcting code and then encrypted by a secret matrix parameterized by the random vector and with noise added by a noise vector, wherein encrypting comprises:
obtaining said secret matrix parameterized by the random vector and with noise by adding together, with a processing device, user secret matrices specific to each of the p encryption users, said user secret matrices being parameterized by the random vector and having noise added by respective noise vectors specific to the p encrypting users.

11. (canceled)

12. A non-transitory data medium having recorded thereon a computer program comprising instructions which, when executed by a processor perform steps of:
decrypting, performed by a second subset of q decrypting users, a ciphertext message element associated with a random vector by a first subset of p encrypting users, wherein the message element is encoded using an error correcting code and then encrypted by a secret matrix parameterized by the random vector and with noise added by a noise vector, wherein decrypting comprises:
the q decrypting users calculating q respective vectors (v_{dj}), each decrypting user vector comprising a matrix specific to said user parameterized with the random vector;
for at least q−1 decrypting users, generating a noise vector specific to that user;
calculating with a processing device the sum of the ciphertext message element, plus the q calculated respective vectors, plus the at least q−1 generated noise vectors; and
decoding the calculated sum using the error correcting code used during encryption so as to obtain the plaintext message element.
